(19) United States
(12) Patent Application Publication
(10) Pub. No.: US 2005/0077904 A1
(43) Pub. Date: Apr. 14, 2005

(54) Electronic battery tester with probe light

(75) Inventor: Kevin I. Bertness, Batavia, IL (US)

Correspondence Address: Alan G. Rego;Westman, Champlin & Kelly, Suite 1600, 900 Second Avenue South, Minneapolis, MN, 55402-3319, US

(73) Assignee: Midtronics, Inc., Willowbrook, IL (US)

(21) Appl. No.: 10/681,666

(22) Filed: Oct. 8, 2003

(51) Int. Cl. G01N 27/416

(52) U.S. Cl. 324/426

(57) ABSTRACT

An electronic battery tester for testing a storage battery includes first and second Kelvin connections configured to couple to the battery. A forcing function applies a time varying signal to the battery through the first and second Kelvin connections. Further, a probe light is configured to couple to at least one of the first and second Kelvin connections. A microprocessor tests the storage battery as a function of a dynamic parameter measured through the first and second Kelvin connections in response to the applied time varying signal.

### BACKGROUND OF THE INVENTION

The present invention relates to storage batteries. More specifically, the present invention relates to electronic battery testers used to test storage batteries.

Storage batteries, such as lead acid storage batteries, are used in a variety of applications such as automotive vehicles and standby power sources. Typical storage batteries consist of a plurality of individual storage cells which are electrically connected in series. Each cell can have a voltage potential of about 2.1 volts, for example. By connecting the cells in the series, the voltages of the individual cells are added in a cumulative manner. For example, in a typical automotive storage battery, six storage cells are used to provide a total voltage of about 12.6 volts. The individual cells are held in a housing and the entire assembly is commonly referred to as the “battery.”

It is frequently desirable to ascertain the condition of a storage battery. Various testing techniques have been developed over the long history of storage batteries. For example, one technique involves the use of a hygrometer in which the specific gravity of the acid mixture in the battery is measured. Electrical testing has also been used to provide less invasive battery testing techniques. A very simple electrical test is to simply measure the voltage across the battery. If the voltage is below a certain threshold, the battery is determined to be bad. Another technique for testing a battery is referred to as a load test. In a load test, the battery is discharged using a known load. As the battery is discharged, the voltage across the battery is monitored and used to determine the condition of the battery. More recently, techniques have been pioneered by Dr. Keith S. Champlin and Midtronics, Inc. of Willowbrook, Ill. for testing storage battery by measuring a dynamic parameter of the battery such as the dynamic conductance of the battery. These techniques are described in a number of United States patents, for example, U.S. Pat. No. 3,873,911, issued Mar. 25, 1975, to Champlin, entitled ELECTRONIC BATTERY TESTING DEVICE; U.S. Pat. No. 3,909,708, issued Sep. 30, 1975, to Champlin, entitled ELECTRONIC BATTERY TESTING DEVICE; U.S. Pat. No. 4,816,768, issued Mar. 28, 1989, to Champlin, entitled ELECTRONIC BATTERY TESTING DEVICE; U.S. Pat. No. 4,825,170, issued Apr. 25, 1989, to Champlin, entitled ELECTRONIC BATTERY TESTING DEVICE WITH AUTOMATIC VOLTAGE SCALING; U.S. Pat. No. 4,881,038, issued Nov. 14, 1989, to Champlin, entitled ELECTRONIC BATTERY TESTING DEVICE WITH AUTOMATIC VOLTAGE SCALING TO DETERMINE DYNAMIC CONDUCTANCE; U.S. Pat. No. 4,912,416, issued Mar. 27, 1990, to Champlin, entitled ELECTRONIC BATTERY TESTING DEVICE WITH STATE-OF-CHARGE COMPENSATION; U.S. Pat. No. 5,140,269, issued Aug. 18, 1992, to Champlin, entitled ELECTRONIC TESTER FOR ASSESSING BATTERY/CELL CAPACITY; U.S. Pat. No. 5,343,380, issued Aug. 30, 1994, entitled METHOD AND APPARATUS FOR SUPPRESSING TIME VARYING SIGNALS IN BATTERIES UNDERGOING CHARGING OR DISCHARGING; U.S. Pat. No. 5,572,136, issued Nov. 5, 1996, entitled ELECTRONIC BATTERY TESTER WITH AUTOMATIC COMPENSATION FOR LOW STATE-OF-CHARGE; U.S. Pat. No. 5,574,355, issued Nov. 12, 1996, entitled METHOD AND APPARATUS FOR DETECTION AND CONTROL OF THERMAL RUNAWAY IN A BATTERY UNDER CHARGE; U.S. Pat. No. 5,585,416, issued Dec. 10, 1996, entitled APPARATUS AND METHOD FOR STEP-CHARGING BATTERIES TO OPTIMIZE CHARGE ACCEPTANCE; U.S. Pat. No. 5,585,728, issued Dec. 17, 1996, entitled ELECTRONIC BATTERY TESTER WITH AUTOMATIC COMPENSATION FOR LOW STATE-OF-CHARGE; U.S. Pat. No. 5,589,757, issued Dec. 31, 1996, entitled APPARATUS AND METHOD FOR STEP-CHARGING BATTERIES TO OPTIMIZE CHARGE ACCEPTANCE; U.S. Pat. No. 5,592,093, issued Jan. 7, 1997, entitled ELECTRONIC BATTERY TESTING DEVICE LOOSE TERMINAL CONNECTION DETECTION VIA A COMPARISON CIRCUIT; U.S. Pat. No. 5,598,098, issued Jan. 28, 1997, entitled ELECTRONIC BATTERY TESTER WITH VERY HIGH NOISE IMMUNITY; U.S. Pat. No. 5,656,920, issued Aug. 12, 1997, entitled METHOD FOR OPTIMIZING THE CHARGING LEAD-ACID BATTERIES AND AN INTERACTIVE CHARGER; U.S. Pat. No. 5,757,192, issued May 26, 1998, entitled METHOD AND APPARATUS FOR DETECTING A BAD CELL IN A STORAGE BATTERY; U.S. Pat. No. 5,821,756, issued Oct. 13, 1998, entitled ELECTRONIC BATTERY TESTER WITH TAILORED COMPENSATION FOR LOW STATE-OF-CHARGE; U.S. Pat. No. 5,831,435, issued Nov. 3, 1998, entitled BATTERY TESTER FOR JIS STANDARD; U.S. Pat. No. 5,914,605, issued Jun. 22, 1999, entitled ELECTRONIC BATTERY TESTER; U.S. Pat. No. 5,945,829, issued Aug. 31, 1999, entitled MIDPOINT BATTERY MONITORING; U.S. Pat. No. 6,002,238, issued Dec. 14, 1999, entitled METHOD AND APPARATUS FOR MEASURING COMPLEX IMPEDANCE OF CELLS AND BATTERIES; U.S. Pat. No. 6,037,751, issued Mar. 14, 2000, entitled APPARATUS FOR CHARGING BATTERIES; U.S. Pat. No. 6,037,777, issued Mar. 14, 2000, entitled METHOD AND APPARATUS FOR DETERMINING BATTERY PROPERTIES FROM COMPLEX IMPEDANCE/ADMITTANCE; U.S. Pat. No. 6,051,976, issued Apr. 18, 2000, entitled METHOD AND APPARATUS FOR AUDITING A BATTERY TEST; U.S. Pat. No. 6,081,098, issued Jun. 27, 2000, entitled METHOD AND APPARATUS FOR CHARGING A BATTERY; U.S. Pat. No. 6,091,245, issued Jul. 18, 2000, entitled METHOD AND APPARATUS FOR AUDITING A BATTERY TEST; U.S. Pat. No. 6,104,167, issued Aug. 15, 2000, entitled METHOD AND APPARATUS FOR CHARGING A BATTERY; U.S. Pat. No. 6,137,269, issued Oct. 24, 2000, entitled METHOD AND APPARATUS FOR ELECTRONICALLY EVALUATING THE INTERNAL TEMPERATURE OF AN ELECTROCHEMICAL CELL OR BATTERY; U.S. Pat. No. 6,163,156, issued Dec. 19, 2000, entitled ELECTRICAL CONNECTION FOR ELECTRONIC BATTERY TESTER; U.S. Pat. No. 6,172,483, issued Jan. 9, 2001, entitled METHOD AND APPARATUS FOR MEASURING COMPLEX IMPEDANCE OF CELL AND BATTERIES; U.S. Pat. No. 6,172,505, issued Jan. 9, 2001, entitled ELECTRONIC BATTERY TESTER; U.S. Pat. No. 6,222,369, issued Apr. 24, 2001, entitled METHOD AND APPARATUS FOR DETERMINING BATTERY PROPERTIES FROM COMPLEX IMPEDANCE/ADMITTANCE; U.S. Pat. No. 6,225,808, issued May 1, 2001, entitled TEST COUNTER FOR ELECTRONIC BATTERY TESTER; U.S. Pat. No. 6,249,124, issued Jun. 19, 2001, entitled ELECTRONIC BATTERY TESTER WITH INTERNAL BATTERY; U.S. Pat. No. 6,259,254, issued Jul. 10, 2001, entitled APPARATUS AND METHOD FOR CARRYING OUT DIAGNOSTIC TESTS ON BATTERIES AND FOR RAPIDLY CHARGING BATTERIES; U.S. Pat. No. 6,262,563, issued Jul. 17, 2001, entitled METHOD AND APPARATUS FOR MEASURING COMPLEX ADMITTANCE OF CELLS AND BATTERIES; U.S. Pat. No. 6,294,896, issued Sep. 25, 2001; entitled METHOD AND APPARATUS FOR MEASURING COMPLEX SELF-IMMITANCE OF A GENERAL ELECTRICAL ELEMENT; U.S. Pat. No. 6,294,897, issued Sep. 25, 2001, entitled METHOD AND APPARATUS FOR ELECTRONICALLY EVALUATING THE INTERNAL TEMPERATURE OF AN ELECTROCHEMICAL CELL OR BATTERY; U.S. Pat. No. 6,304,087, issued Oct. 16, 2001, entitled APPARATUS FOR CALIBRATING ELECTRONIC BATTERY TESTER; U.S. Pat. No. 6,310,481, issued Oct. 30, 2001, entitled ELECTRONIC BATTERY TESTER; U.S. Pat. No. 6,313,607, issued Nov. 6, 2001, entitled METHOD AND APPARATUS FOR EVALUATING STORED CHARGE IN AN ELECTROCHEMICAL CELL OR BATTERY; U.S. Pat. No. 6,313,608, issued Nov. 6, 2001, entitled METHOD AND APPARATUS FOR CHARGING A BATTERY; U.S. Pat. No. 6,316,914, issued Nov. 13, 2001, entitled TESTING PARALLEL STRINGS OF STORAGE BATTERIES; U.S. Pat. No. 6,323,650, issued Nov. 27, 2001, entitled ELECTRONIC BATTERY TESTER; U.S. Pat. No. 6,329,793, issued Dec. 11, 2001, entitled METHOD AND APPARATUS FOR CHARGING A BATTERY; U.S. Pat. No. 6,331,762, issued Dec. 18, 2001, entitled ENERGY MANAGEMENT SYSTEM FOR AUTOMOTIVE VEHICLE; U.S. Pat. No. 6,332,113, issued Dec. 18, 2001, entitled ELECTRONIC BATTERY TESTER; U.S. Pat. No. 6,351,102, issued Feb. 26, 2002, entitled AUTOMOTIVE BATTERY CHARGING SYSTEM TESTER; U.S. Pat. No. 6,359,441, issued Mar. 19, 2002, entitled ELECTRONIC BATTERY TESTER; U.S. Pat. No. 6,363,303, issued Mar. 26, 2002, entitled ALTERNATOR DIAGNOSTIC SYSTEM, U.S. Pat. No. 6,392,414, issued May 21, 2002, entitled ELECTRONIC BATTERY TESTER; U.S. Pat. No. 6,417,669, issued Jul. 9, 2002, entitled SUPPRESSING INTERFERENCE IN AC MEASUREMENTS OF CELLS, BATTERIES AND OTHER ELECTRICAL ELEMENTS; U.S. Pat. No. 6,424,158, issued Jul. 23, 2002, entitled APPARATUS AND METHOD FOR CARRYING OUT DIAGNOSTIC TESTS ON BATTERIES AND FOR RAPIDLY CHARGING BATTERIES; U.S. Pat. No. 6,441,585, issued Aug. 17, 2002, entitled APPARATUS AND METHOD FOR TESTING RECHARGEABLE ENERGY STORAGE BATTERIES; U.S. Pat. No. 6,445,158, issued Sep. 3, 2002, entitled VEHICLE ELECTRICAL SYSTEM TESTER WITH ENCODED OUTPUT; U.S. Pat. No. 6,456,045, issued Sep. 24, 2002, entitled INTEGRATED CONDUCTANCE AND LOAD TEST BASED ELECTRONIC BATTERY TESTER; U.S. Pat. No. 6,466,025, issued Oct. 15, 2002, entitled ALTERNATOR TESTER; U.S. Pat. No. 6,466,026, issued Oct. 15, 2002, entitled PROGRAMMABLE CURRENT EXCITER FOR MEASURING AC IMMITTANCE OF CELLS AND BATTERIES; U.S. Pat. No. 6,534,993, issued Mar. 18, 2003, entitled ELECTRONIC BATTERY TESTER; U.S. Pat. No. 6,544,078, issued Apr. 8, 2003, entitled BATTERY CLAMP WITH INTEGRATED CURRENT SENSOR; U.S. Pat. No. 6,556,019, issued Apr. 29, 2003, entitled ELECTRONIC BATTERY TESTER; U.S. Pat. No. 6,566,883, issued May 20, 2003, entitled ELECTRONIC BATTERY TESTER; U.S. Pat. No. 6,586,941, issued Jul. 1, 2003, entitled BATTERY TESTER WITH DATABUS; U.S. Pat. No. 6,597,150, issued Jul. 22, 2003, entitled METHOD OF DISTRIBUTING JUMP-START BOOSTER PACKS; U.S. Ser. No. 09/780,146,filed Feb. 9, 2001, entitled STORAGE BATTERY WITH INTEGRAL BATTERY TESTER; U.S. Ser. No. 09/756,638, filed Jan. 8, 2001, entitled METHOD AND APPARATUS FOR DETERMINING BATTERY PROPERTIES FROM COMPLEX IMPEDANCE/ADMITTANCE; U.S. Ser. No. 09/862,783, filed May 21, 2001, entitled METHOD AND APPARATUS FOR TESTING CELLS AND BATTERIES EMBEDDED IN SERIES/PARALLEL SYSTEMS; U.S. Ser. No. 09/960,117, filed Sep. 20, 2001, entitled IN-VEHICLE BATTERY MONITOR; U.S. Ser. No. 09/908,278, filed Jul. 18, 2001, entitled BATTERY CLAMP WITH EMBEDDED ENVIRONMENT SENSOR; U.S. Ser. No. 09/880,473, filed Jun. 13, 2001; entitled BATTERY TEST MODULE; U.S. Ser. No. 09/940,684, filed Aug. 27, 2001, entitled METHOD AND APPARATUS FOR EVALUATING STORED CHARGE IN AN ELECTROCHEMICAL CELL OR BATTERY; U.S. Ser. No. 60/330,441, filed Oct. 17, 2001, entitled ELECTRONIC BATTERY TESTER WITH RELATIVE TEST OUTPUT; U.S. Ser. No. 60/348,479, filed Oct. 29, 2001, entitled CONCEPT FOR TESTING HIGH POWER VRLA BATTERIES; U.S. Ser. No. 10/046,659, filed Oct. 29, 2001, entitled ENERGY MANAGEMENT SYSTEM FOR AUTOMOTIVE VEHICLE; U.S. Ser. No. 09/993,468, filed Nov. 14, 2001, entitled KELVIN CONNECTOR FOR A BATTERY POST; U.S. Ser. No. 09/992,350, filed Nov. 26, 2001, entitled ELECTRONIC BATTERY TESTER, U.S. Ser. No. 60/341,902, filed Dec. 19, 2001, entitled BATTERY TESTER MODULE; U.S. Ser. No. 10/042,451, filed Jan. 8, 2002, entitled BATTERY CHARGE CONTROL DEVICE, U.S. Ser. No. 10/073,378, filed Feb. 8, 2002, entitled METHOD AND APPARATUS USING A CIRCUIT MODEL TO EVALUATE CELL/BATTERY PARAMETERS; U.S. Ser. No. 10/093,853, filed Mar. 7, 2002, entitled ELECTRONIC BATTERY TESTER WITH NETWORK COMMUNICATION; U.S. Ser. No. 60/364,656, filed Mar. 14, 2002, entitled ELECTRONIC BATTERY TESTER WITH LOW TEMPERATURE RATING DETERMINATION; U.S. Ser. No. 10/098,741, filed Mar. 14, 2002, entitled METHOD AND APPARATUS FOR AUDITING A BATTERY TEST; U.S. Ser. No. 10/112,114, filed Mar. 28, 2002; U.S. Ser. No. 10/109,734, filed Mar. 28, 2002; U.S. Ser. No. 10/112,105, filed Mar. 28, 2002, entitled CHARGE CONTROL SYSTEM FOR A VEHICLE BATTERY; U.S. Ser. No. 10/112,998, filed Mar. 29, 2002, entitled BATTERY TESTER WITH BATTERY REPLACEMENT OUTPUT; U.S. Ser. No. 10/119,297, filed Apr. 9, 2002, entitled METHOD AND APPARATUS FOR TESTING CELLS AND BATTERIES EMBEDDED IN SERIES/PARALLEL SYSTEMS; U.S. Ser. No. 60/379,281, filed May 8, 2002, entitled METHOD FOR DETERMINING BATTERY STATE OF CHARGE; U.S. Ser. No. 60/387,046, filed Jun. 7, 2002, entitled METHOD AND APPARATUS FOR INCREASING THE LIFE OF A STORAGE BATTERY; U.S. Ser. No. 10/177,635, filed Jun. 21, 2002, entitled BATTERY CHARGER WITH BOOSTER PACK; U.S. Ser. No. 10/207,495, filed Jul. 29, 2002, entitled KELVIN CLAMP FOR ELECTRICALLY COUPLING TO A BATTERY CONTACT; U.S. Ser. No. 10/200,041, filed Jul 19, 2002, entitled AUTOMOTIVE VEHICLE ELECTRICAL SYSTEM DIAGNOSTIC DEVICE; U.S. Ser. No. 10/217,913, filed Aug. 13, 2002, entitled, BATTERY TEST MODULE; U.S. Ser. No. 60/408,542, filed Sep. 5, 2002, entitled BATTERY TEST OUTPUTS ADJUSTED BASED UPON TEMPERATURE; U.S. Ser. No. 10/246,439, filed Sep. 18, 2002, entitled BATTERY TESTER UPGRADE USING SOFTWARE KEY; U.S. Ser. No. 60/415,399, filed Oct. 2, 2002, entitled QUERY BASED ELECTRONIC BATTERY TESTER; and U.S. Ser. No. 10/263,473, filed Oct. 2, 2002, entitled ELECTRONIC BATTERY TESTER WITH RELATIVE TEST OUTPUT; U.S. Ser. No. 60/415,796, filed Oct. 3, 2002, entitled QUERY BASED ELECTRONIC BATTERY TESTER; U.S. Ser. No. 10/271,342, filed Oct. 15, 2002, entitled IN-VEHICLE BATTERY MONITOR; U.S. Ser. No. 10/270,777, filed Oct. 15, 2002, entitled PROGRAMMABLE CURRENT EXCITER FOR MEASURING AC IMMITTANCE OF CELLS AND BATTERIES; U.S. Ser. No. 10/310,515, filed Dec. 5, 2002, entitled BATTERY TEST MODULE; U.S. Ser. No. 10/310,490, filed Dec. 5, 2002, entitled ELECTRONIC BATTERY TESTER; U.S. Ser. No. 10/310,385, filed Dec. 5, 2002, entitled BATTERY TEST MODULE, U.S. Ser. No. 60/437,255, filed Dec. 31, 2002, entitled REMAINING TIME PREDICTIONS, U.S. Ser. No. 60/437,224, filed Dec. 31, 2002, entitled DISCHARGE VOLTAGE PREDICTIONS, U.S. Ser. No. 10/349,053, filed Jan. 22, 2003, entitled APPARATUS AND METHOD FOR PROTECTING A BATTERY FROM OVERDISCHARGE, U.S. Ser. No. 10/388,855, filed Mar. 14, 2003, entitled ELECTRONIC BATTERY TESTER WITH BATTERY FAILURE TEMPERATURE DETERMINATION, U.S. Ser. No. 10/396,550, filed Mar. 25, 2003, entitled ELECTRONIC BATTERY TESTER, U.S. Ser. No. 60/467,872, filed May 5, 2003, entitled METHOD FOR DETERMINING BATTERY STATE OF CHARGE, U.S. Ser. No. 60/477,082, filed Jun. 9, 2003, entitled ALTERNATOR TESTER, U.S. Ser. No. 10/460,749, filed Jun. 12, 2003, entitled MODULAR BATTERY TESTER FOR SCAN TOOL, U.S. Ser. No. 10/462,323, filed Jun. 16, 2003, entitled ELECTRONIC BATTERY TESTER HAVING A USER INTERFACE TO CONFIGURE A PRINTER, U.S. Ser. No. 10/601,608, filed Jun. 23, 2003, entitled CABLE FOR ELECTRONIC BATTERY TESTER, U.S. Ser. No. 10/601,432, filed Jun. 23, 2003, entitled BATTERY TESTER CABLE WITH MEMORY; U.S. Ser. No. 60/490,153, filed Jul. 25, 2003, entitled SHUNT CONNECTION TO A PCB FOR AN ENERGY MANAGEMENT SYSTEM EMPLOYED IN AN AUTOMOTIVE VEHICLE, U.S. Ser. No. 10/653,342, filed Sep. 2, 2003, entitled ELECTRONIC BATTERY TESTER CONFIGURED TO PREDICT A LOAD TEST RESULT, U.S. Ser. No. 10/654,098, filed Sep. 3, 2003, entitled BATTERY TEST OUTPUTS ADJUSTED BASED UPON BATTERY TEMPERATURE AND THE STATE OF DISCHARGE OF THE BATTERY, U.S. Ser. No. 10/656,526, filed Sep. 5, 2003, entitled METHOD AND APPARATUS FOR MEASURING A PARAMETER OF A VEHICLE ELECTRICAL SYSTEM, U.S. Ser. No. 10/656,538, filed Sep. 5, 2003, entitled ALTERNATOR TESTER WITH ENCODED OUTPUT, which are incorporated herein in their entirety.

In general, when required, separate lighting equipment such as a torch is utilized to illuminate a battery environment during battery testing. However, employing separate lighting equipment during battery testing makes the testing and lighting equipment difficult to properly position and operate in a constrained and poorly lit environment associated with, for example, testing of batteries wherein the battery terminals are recessed in cabinets.

### SUMMARY OF THE INVENTION

An electronic battery tester for testing a storage battery includes first and second Kelvin connections configured to couple to the battery. A forcing function applies a time varying signal to the battery through the first and second Kelvin connections. Further, a probe light is configured to couple to at least one of the first and second Kelvin connections. A microprocessor tests the storage battery as a function of a dynamic parameter measured through the first and second Kelvin connections in response to the applied time varying signal.

### BRIEF DESCRIPTION OF THE DRAWINGS

FIGS. 1, 2 and 3 are simplified block diagrams of battery testers in accordance with embodiments of the present invention.

FIG. 4 shows a perspective view of a battery tester Kelvin clamp to which a probe light is coupled in accordance with another embodiment of the present invention.

### DETAILED DESCRIPTION OF THE PREFERRED EMBODIMENTS

The present invention includes an electronic battery tester which measures a dynamic parameter of a battery using Kelvin connections. The battery tester includes a probe light configured to couple to the Kelvin connections. The probe light helps illuminate the battery environment during battery testing.

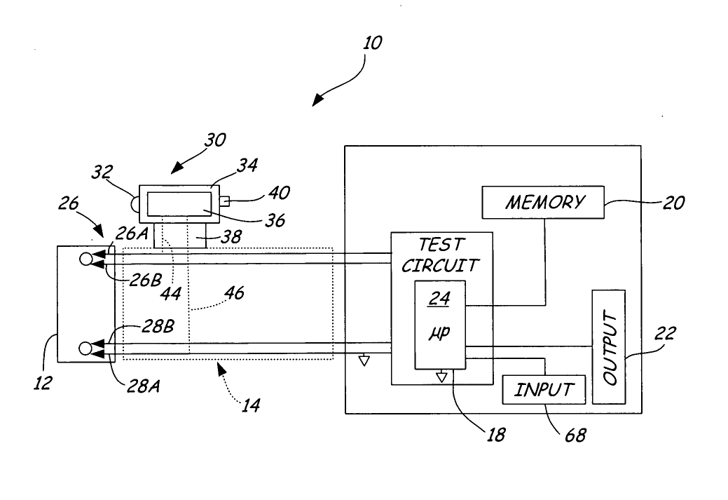

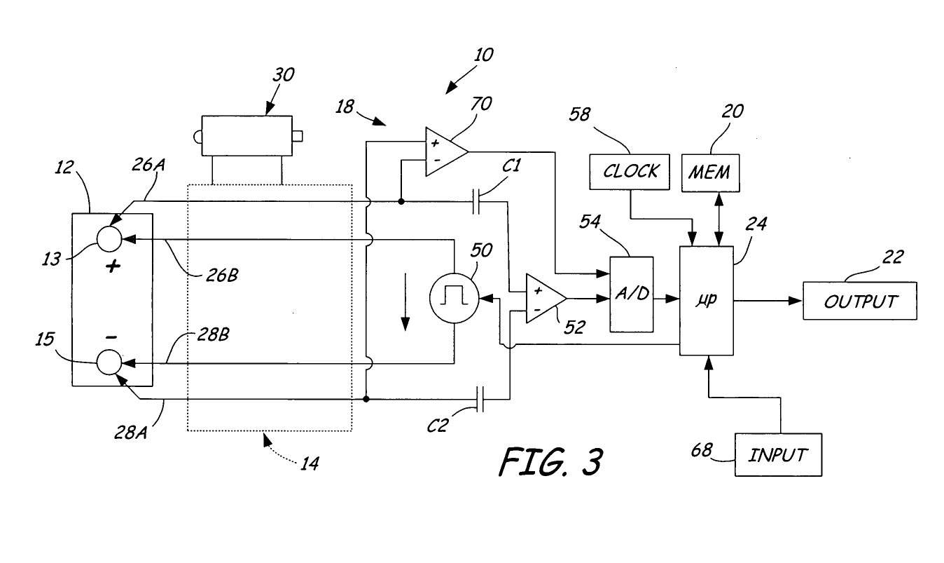

FIG. 1 is a simplified block diagram of electronic battery tester 10, which includes a probe light 30, in accordance with an embodiment of the present invention. The same reference numerals are used in the various figures to represent the same or similar elements. Note that FIG. 1 is a simplified block diagram of a specific type of battery tester. However, the present invention is applicable to any type of battery tester including those which do not use dynamic parameters. Other types of example testers include testers that conduct load tests, current based tests, voltage based tests, tests which apply various conditions or observe various performance parameters of a battery, etc. Battery tester 10 includes a test circuit 18, a memory 20, an input 68, an output 22, cable(s) or probe(s) 14 and probe light 30. Test circuit 18 includes a microprocessor system 24 and other circuitry, shown in FIG. 3, configured to measure a dynamic parameter of battery 12. As used herein, a dynamic parameter is one which is related to a signal having an alternating current (AC) component. The signal can be either applied directly or drawn from battery 12. Example dynamic parameters include dynamic resistance, conductance, impedance, admittance, etc. This list is not exhaustive, for example, a dynamic parameter can include a component value of an equivalent circuit of battery 12. Microprocessor system 24 controls the operation of other components within test circuitry 18 and, in turn, carries out different battery testing functions based upon battery testing instructions stored in memory 20.

In the embodiment shown in FIG. 1, cable 14 includes a four-point connection known as a Kelvin connection formed by connections 26 and 28. With such a Kelvin connection, two couplings are provided to the positive and negative terminals of battery 12. First Kelvin connection 26 includes a first conductor 26A and a second conductor 26B, which couple to test circuit 18. Similarly, first conductor 28A and second conductor 28B of second Kelvin connection 28 also couple to test circuit 18. Employing Kelvin connections 26 and 28 allows one of the electrical connections on each side of battery 12 to carry large amounts of current while the other pair of connections can be used to obtain accurate voltage readings. Note that in other embodiments of the present invention, instead of employing Kelvin connections 26 and 28, cable 14 can include a single conductor to couple the first battery terminal to test circuit 18 and a single conductor to couple the second battery terminal to test circuit 18. Details regarding testing battery 12 with the help of Kelvin connections 26 and 28 are provided further below in connection with FIG. 3.

As can be seen in FIG. 1, probe light 30, which releasably couples to cable 14, includes a light bulb 32, a housing 34, power control circuitry 36 and a switch 40. Housing 34, which may be formed of any suitable insulating material (such as plastic), substantially encloses power control circuitry 36. A lamp holder or socket (not shown), into which light bulb 32 is inserted, is included within housing 34. Power control circuitry 36 electrically couples to the lamp holder or socket. Probe light-to-cable connector 38, which is configured to couple probe light 30 to cable 14, is shown as a single block in the interest of simplification. However, depending upon the type of coupling desired between probe light 30 and cable 14, probe light-to-cable connector 38 may include one or more components of any suitable design. In some embodiments, probe light 30 releasably mechanically couples to cable 14 and therefore probe light-to-cable connector 38 may include pieces of Velcro (attached to housing 34, of probe light 30, and to cable 14), for example. In some embodiments, instead of Velcro pieces, probe-light-to-cable connector 38 may comprise a double-sided adhesive tape. In other such embodiments, probe-light-to-cable connector 38 may comprise a loop (formed of plastic, for example) that is configured to fit around cable 14. The loop may be formed integral with housing 34. In some embodiments, probe light-to-cable connector 38 may comprise a Velcro strap that is attached to housing 34, of probe light 30, and configured to wrap around cable 14. In some embodiments, probe 30 is configured to releasably mechanically and electrically couple to cable 14. In such embodiments, probe light-to-cable connector 38 may include any suitable male and female plug fittings capable of providing the releasable mechanical and electrical coupling between probe 30 and cable 14. For simplification, dashed lines 44 and 46 are used in FIG. 1 to denote releasable electrical coupling between power control circuitry 36, of probe light 30, and conductors of cable 14. In some embodiments of the present invention, power control circuitry 36 includes non-rechargeable batteries (lithium coin cells, AA batteries, AAA batteries, etc.) that provide power to light bulb 32. In some embodiments, power is supplied to light bulb 32 from test circuitry 18. For simplification, components such as pull up and/or pull down resistors and other power supply circuitry that may be employed within test circuitry 18 to provide power to probe light 30 are not shown. Light bulb 30 can be switched on and off using switch 40 and/or form a push button (not shown), for example, included in input 68. In some embodiments, power control circuit circuitry 36 includes rechargeable batteries/capacitors that can be recharged by the battery under test (such as 12) when it is coupled to tester 10. Incandescent lamps, cold-cathode lamps, etc., may be employed as light bulb 32.

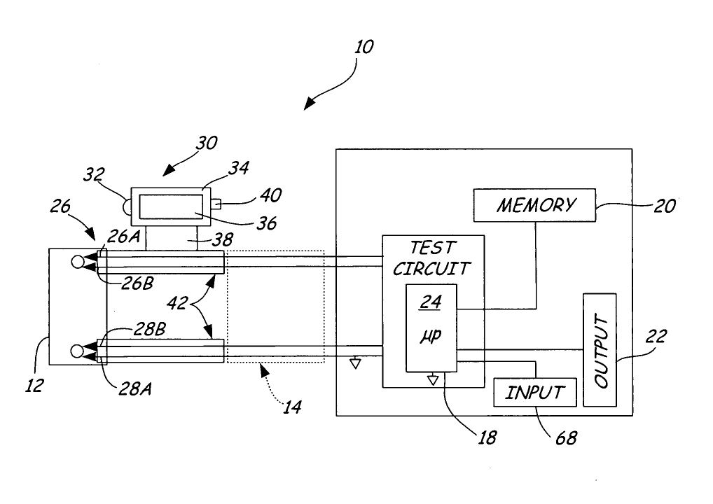

FIG. 2 is a simplified block diagram of electronic battery tester 10, which includes a probe light 30 that couples to probe extension(s) 42 in accordance with an embodiment of the present invention. Probe extensions 42 are used, for example, when testing batteries employed in Uninterruptible Power Supply (UPS) and telecommunication (telecom) applications. Here, the batteries are in racks with very small clearance between the batteries and very little light, since no light is needed for the batteries to operate. Under such conditions, probe light 30, mounted on probe extension(s) 42, helps provide the necessary illumination to ensure that proper selection of battery terminals takes place and proper connection to the selected battery terminals is made by probe extensions 42, which are used to reach the terminals. In the embodiment of the present invention shown in FIG. 2, the coupling of probe light 30, to probe extension(s) 42, and the powering and operation of probe light 30 is carried out in a manner similar to that described in connection with FIG. 1 above.

FIG. 3 is a simplified block diagram of electronic battery tester 10 showing components of test circuit 18. In addition to microprocessor system 24, test circuit 18 also includes forcing function 50, differential amplifier 52 and analog-to-digital converter 54. Amplifier 52 is capacitively coupled to battery 12 through capacitors C₁ and C₂. Amplifier 52 has an output connected to an input of analog-to-digital converter 54 which in turn has an output connected to microprocessor system 24. Microprocessor system 24 is also capable of receiving an input from input device 68.

During testing of battery 12, forcing function 50 is controlled by microprocessor system 24 and provides a current I in the direction shown by the arrow in FIG. 3. In one embodiment, this is a sine wave, square wave or a pulse. Differential amplifier 52 is connected to terminals 13 and 15 of battery 12 through capacitors C₁ and C₂, respectively, and provides an output related to the voltage potential difference between terminals 13 and 15. In a preferred embodiment, amplifier 52 has a high input impedance. Tester 10 includes differential amplifier 70 having inverting and noninverting inputs connected to terminals 13 and 15, respectively. Amplifier 70 is connected to measure the open circuit potential voltage (V_{BAT}) of battery 12 between terminals 13 and 15 and is one example of a dynamic response sensor used to sense the time varying response of the battery 12 to the applied time varying current. The output of amplifier 70 is provided to analog-to-digital converter 54 such that the voltage across terminals 13 and 15 can be measured by microprocessor system 24. The output of differential amplifier 52 is converted to a digital format and is provided to microprocessor system 24. Microprocessor system 24 operates at a frequency determined by system clock 58 and in accordance with programmable instructions stored in memory 20.

Microprocessor system 24 determines the conductance of battery 12 by applying a current pulse I using forcing function 50. This measurement provides a dynamic parameter related to the battery. Of course, any such dynamic parameter can be measured including resistance, admittance, impedance or their combination along with conductance. Further, any type of time varying signal can be used to obtain the dynamic parameter. The signal can be generated using an active forcing function or using a forcing function which provides a switchable load, for example, coupled to the battery 12. The processing circuitry determines the change in battery voltage due to the current pulse I using amplifier 52 and analog-to-digital converter 54. The value of current I generated by forcing function 50 is known and is stored in memory 20. In one embodiment, current I is obtained by applying a load to battery 12. Microprocessor system 24 calculates the conductance of battery 12 using the following equation:

$${G}_{BAT} = \frac{Δ I}{Δ V} \qquad Equation 1$$

where ΔI is the change in current flowing through battery 12 due to forcing function 50 and ΔV is the change in battery voltage due to applied current ΔI. Based upon the battery conductance G_{BAT} and the battery voltage, the battery tester 10 determines the condition of battery 12. Battery tester 10 is programmed with information which can be used with the determined battery conductance and voltage as taught in the above listed patents to Dr. Champlin and Midtronics, Inc.

The tester can compare the measured CCA (Cold Cranking Amp) with the rated CCA for that particular battery. Additional information relating to the conditions of the battery test (such as battery temperature, time, date, etc.) can be received by microprocessor system 24 from input device 68. Further, as mentioned above, in some embodiments, probe light 30 can be turned on and off from input 68.

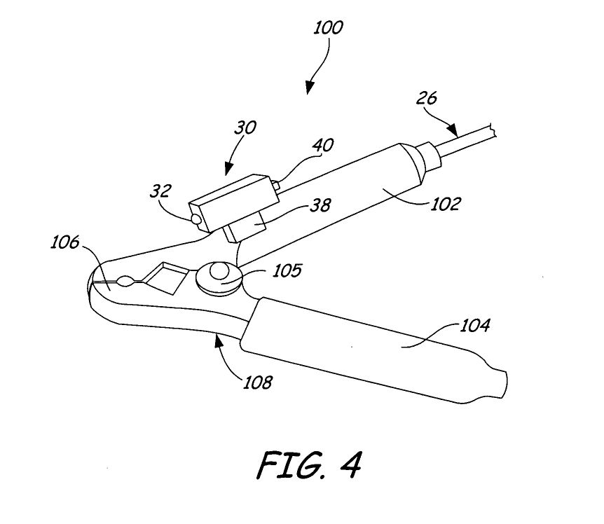

FIG. 4 shows a perspective view of a battery tester Kelvin clamp 100 to which probe light 30 is coupled in accordance with another embodiment of the present invention. Kelvin clamp 100 helps couple a Kevlin connection (such as 26) of cable 14 (not shown in FIG. 4) to a battery terminal (such as 13 (not shown in FIG. 4) ). As can be seen in FIG. 4, clamp 100 includes a Plier-Type clip 108 having arms 102 and 104 connected together by pivot 105 and a terminal gripping portion 106 that can be opened or closed with the help of arms 102 and 104. As in the case of the above-described embodiments, probe light 30 helps provide the necessary illumination to ensure that proper selection of the battery terminal(s) takes place and proper connection to the selected battery terminals is made by Kelvin clamp 100. For simplification, individual conductors of Kelvin connection 26 are not shown in FIG. 4. In the embodiment of the present invention shown in FIG. 4, the coupling of probe light 30, to Kelvin clamp 100, and the powering and operation of probe light 30 is carried out in a manner similar to that described in connection with FIG. 1 above.

Although the present invention has been described with reference to preferred embodiments, workers skilled in the art will recognize that changes may be made in form and detail without departing from the spirit and scope of the invention.

1. An electronic battery tester for testing a storage battery comprising:
a first Kelvin connection configured to electrically couple to a first terminal of the battery;
a second Kelvin connection configured to electrically couple to a second terminal of the battery;
a probe light configured to couple to at least one of the first and second Kelvin connections; and
battery test circuitry configured to measure a parameter of the battery through the first and second Kelvin connections.

2. The apparatus of claim 1 wherein the parameter of the battery is a dynamic parameter.

3. The apparatus of claim 2 wherein the battery test circuitry comprises:
a forcing function configured to apply a time varying signal to the battery through the first and second Kelvin connections; and
a microprocessor configured to test the storage battery as a function of the dynamic parameter measured through the first and second Kelvin connections in response to the applied time varying signal.

4. The apparatus of claim 1 wherein the probe light is configured to mechanically couple to the at least one of the first and second Kelvin connections.

5. The apparatus of claim 1 wherein the probe light is configured to electrically couple to the at least one of the first and second Kelvin connections.

6. The apparatus of claim 1 wherein the probe light is configured to couple to the at least one of the first and second Kelvin connections via probe extensions.

7. The apparatus of claim 1 wherein the probe light is powered by at least one battery.

8. The apparatus of claim 7 wherein the at least one battery is at least one non-rechargeable battery.

9. The apparatus of claim 8 wherein the at least one non-rechargeable battery is selected from the group consisting of lithium coin cells, AAA and AA batteries.

10. The apparatus of claim 7 wherein the at least one battery is at least one rechargeable battery.

11. The apparatus of claim 10 wherein the at least one rechargeable battery is a part of power control circuitry of the probe light, and wherein the power control circuitry receives a charge signal for charging the at least one rechargeable battery from a battery under test.

12. The apparatus of claim 1 wherein the probe light is configured to receive power from the battery test circuitry.

13. The apparatus of claim 1 further comprising an input, coupled to the test circuitry, through which the probe light can be turned on and off.

14. The apparatus of claim 1 further comprising a probe light-to-cable connector configured to couple the probe light to the at least one of the first and second Kelvin connections.

15. The apparatus of claim 14 wherein the probe light-to-cable connector comprises pieces of Velcro.

16. The apparatus of claim 14 wherein the probe light-to-cable connector comprises a double-sided adhesive tape.

17. The apparatus of claim 14 wherein the probe light-to-cable is a loop configured to fit around a cable including the at least one of the first and second Kelvin connections.

18. The apparatus of claim 17 wherein the loop is formed integral with a housing of the probe light.

19. The apparatus of claim 17 wherein the loop is formed of plastic.

20. The apparatus of claim 14 wherein the probe light-to cable connector comprises a Velcro strap configured to attach to a housing of the probe light and to wrap around a cable including the at least one of the first and second Kelvin connections.

21. The apparatus of claim 14 wherein the probe light-to-cable connector comprises male and female plug fittings.

22. The apparatus of claim 1 wherein the probe light comprises a light bulb.

23. The apparatus of claim 22 wherein the light bulb is selected from the group consisting of incandescent lamps and cold-cathode lamps.

24. The apparatus of claim 22 wherein the light bulb receives power from at least one capacitor.

25. A method of testing a battery comprising:
(a) coupling a first Kelvin connection to a first terminal of the battery;
(b) coupling a second Kelvin connection to a second terminal of the battery;
(c) coupling a probe light to at least one of the first and second Kelvin connections;
(d) measuring a parameter of the battery through the first and second Kelvin connections.

26. The method of claim 23 wherein the probe light is powered by at least one battery.

27. The method of claim 23 wherein step (d) is carried out by battery test circuitry, and wherein the probe light is configured to receive power from the battery test circuitry.
